(19) United States
(12) Patent Application Publication
(10) Pub. No.: US 2006/0187759 A1
(43) Pub. Date: Aug. 24, 2006

(54) Portable electronic timepiece

(76) Inventor: Toshiyuki Fujiwara, Chiba-shi (JP)

Correspondence Address: BRUCE L. ADAMS, ESQ., SUITE 1231, 17 BATTERY PLACE, NEW YORK, NY, 10004, US

(21) Appl. No.: 11/356,705

(22) Filed: Feb. 17, 2006

(30) Foreign Application Priority Data
Feb. 22, 2005 (JP) 2005-046097

(51) Int. Cl. G04C 23/02

(52) U.S. Cl. 368/88

(57) ABSTRACT

To make it possible such that a front button disposed in an armoring case is made the same height as a display face or lower than the display face, and a switch board can be fixed by a simple constitution even if a case back is not closed. A switch spring is extended in a planar manner from a battery accommodation concave part in which a battery has been accommodated to an outside of a lower face of a switch board, and additionally has an elastic end part bent at a right angle to an upper side in the outside of the switch board. A hook locking window is formed in the elastic end part of the switch spring, and a hook is formed in a battery frame made of resin. The switch board disposed between the battery frame and the switch spring is fixed with the battery frame and the switch spring being hook-fastened.

### BACKGROUND OF THE INVENTION

1. Field of the Invention

The present invention relates to a portable electronic timepiece having a front switch in which a switch board has been provided in a position sectionally separated from a circuit board possessing an IC.

2. Description of the Prior Art

Generally, a multifunctional, portable electronic timepiece possesses a switch disposed in a side face side of an armoring case, and a switch disposed in a display side face side in which a time instant and the like are displayed. The former switch is called a front switch.

A conventional front switch structure shown in FIG. 8 of JP-A-2001-272485 is constituted by a front button 10 pushed down by a user, a shaft 20 molded monolithically with this front button 10, and a coil spring 30 wound around the shaft 20. The front button 10 and the coil spring 30 are accommodated in a concave part 210 formed in a case band 101 that is a peripheral edge part of a front side opening of an armoring cover. The coil spring 30 disposed between the front button 10 and a bottom face of the concave part 210 biases the front button 10 in an upward direction. If the front button 10 is pushed down while resisting against a biasing force of the coil spring 30, a conducting member 21 attached to a tip of the shaft 20 contacts with a switch contact 22 of a circuit board 250. By this, the front switch which has been in an OFF state until then is switched to an ON state. In this conventional front switch structure, if the switch contact 22 is disposed on the circuit board 250, the front button 10 of the front switch becomes higher than a display face. For this reason, there has been a problem that a degree of freedom in a design concerning an external shape of the portable electronic timepiece is extremely limited.

Whereupon, as a front switch structure whose degree of freedom in the design concerning the external shape of the portable electronic timepiece is not limited, such one as shown in FIG. 2 has been developed. That is, it is a portable electronic timepiece constituted while containing a circuit board 7 possessing the IC not shown in the drawing, a switch board 13 sectionally separated from the circuit board 7, a conducting coil spring 15 for causing both these boards to conduct, and a front button 10.

An operation part of this front switch is the operation part which operates a switch part from an outside of an armoring case 1, and is insert-disposed in a stepped through-hole la formed in the armoring case 1. The stepped through-hole la has in its outside a large diameter cylinder part, and in its inside a small diameter cylinder part.

The operation part is constituted by the front button 10, a coil spring 11, and a shaft 12. The coil spring 11 is disposed in the large diameter cylinder part of the stepped through-hole 1a. And, the shaft 12 to whose upper end there has been fixed the front button 10 penetrates through the small diameter cylinder part from the large diameter cylinder part of the stepped through-hole 1a, and is disposed while being made movable in an axial direction. Thereupon, a lower end of the shaft 12 faces on a rubber switch 14 with a predetermined distance being spaced.

The switch part is constituted by the switch board 13 in which a switch pattern has been formed, and the rubber switch 14 fixed to a predetermined position on the switch pattern of the switch board 13. The switch board 13 to which the rubber switch 14 has been attached is disposed in a switch attachment concave part of a battery frame 5 after a conducting coil spring 15 has been inserted into a coil spring attachment hole formed in a battery frame 5 while penetrating through it.

And, the switch board 13 is held down to the battery frame 5 by a case back 3 through a plate-like elastic member 17 functioning as a spacer and a cushion. By doing like this, the switch board 13 is accommodated in and fixed to the armoring case 1.

Since it is such a constitution as mentioned above, in the portable electronic timepiece in which the conventional front switch structure has been adopted, the front button of the front switch is lower than the display face, so that it is one whose degree of freedom in the design concerning the external shape is not limited. However, in the portable electronic timepiece in which the conventional front switch structure mentioned above has been adopted, there has been a problem that, unless the case back is tightened, the switch board is not fixed in the armoring case, so that an assembly is difficult. Further, there has been also a problem that, under a module state, an operation inspection of the front switch cannot be performed.

A problem that the present invention is to solve is to make it possible such that, in a portable electronic timepiece in which a switch board has been provided in a position sectionally separated from a circuit board, a front button disposed in an armoring case is made the same height as a display face or lower than the display face, and the switch board can be fixed by a simple constitution even if a case back is not closed.

### SUMMARY OF THE INVENTION

In order to solve the problem mentioned above, in a portable electronic timepiece in which a switch board has been provided in a position sectionally separated from a circuit board possessing an IC, the switch board has been disposed between a battery frame and a switch spring, and has been fixed by hook-fastening-the switch spring to at least any one of the battery frame or a panel frame.

### BRIEF DESCRIPTION OF THE SEVERAL VIEWS OF THE DRAWINGS

A preferred form of the present invention is illustrated in the accompanying drawings in which:

FIG. 1 is a sectional view of a main part of a front switch structure in a portable electronic timepiece of an embodiment 1 of the present invention;

FIG. 2 is a sectional view of the main part of the front switch structure in a conventional portable electronic timepiece.

### DETAILED DESCRIPTION OF THE PREFERRED EMBODIMENTS

The present invention is a portable electronic timepiece in which a switch board has been provided in a position sectionally separated from a circuit board possessing an IC, wherein the switch board has been disposed between a battery frame and a switch spring, and the switch spring has been fixed to the battery frame.

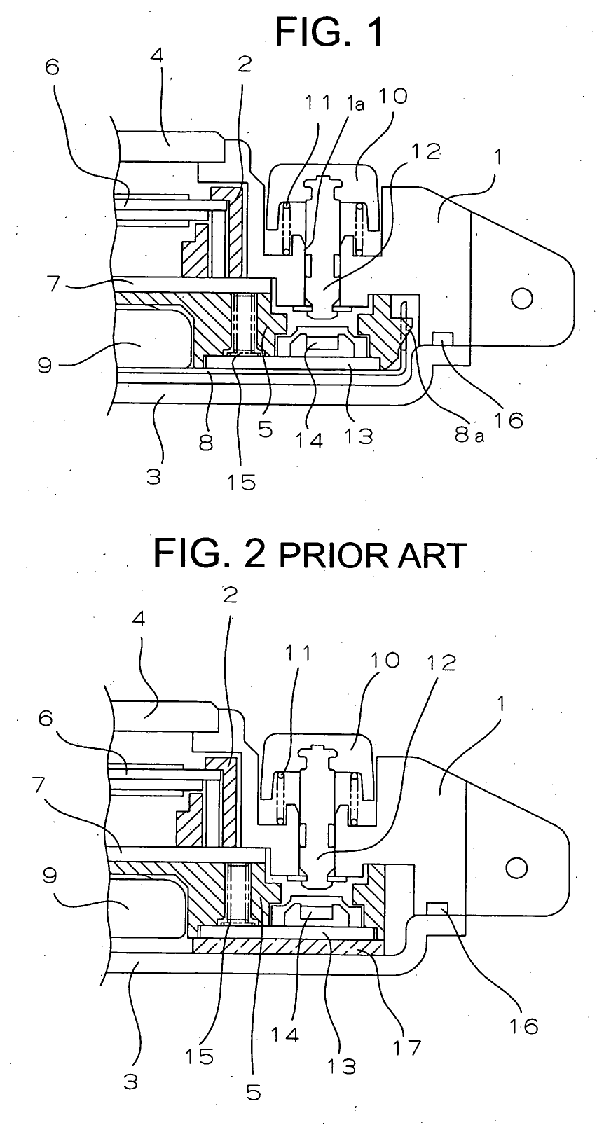

In FIG. 1 that is a main part sectional view of an embodiment 1 of the present invention, inside the armoring case 1 of a portable electronic timepiece there are accommodated constitutional components of a timepiece movement, and its front side opening is sealed by a cover glass 4 and its back side opening by the case back 3, respectively.

The front switch structure is constituted by the circuit board 7 possessing the IC not shown in the drawing, the switch board 13 sectionally separated from the circuit board 7, the conducting coil spring 15 for causing both these boards to conduct, the rubber switch 14 for making a switch ON by being contacted with a pattern of the switch board 13, and the front button 10 that is an outside operation member for pressing the rubber switch 14 from the outside.

The operation part of the front switch is the operation part which operates the switch part from the outside of the armoring case 1, and is insertion-disposed in the stepped through-hole 1a formed in the armoring case 1. The stepped through-hole la has in its outside the large diameter cylinder part, and in its inside the small diameter cylinder part.

The operation part is constituted by the front button 10, the coil spring 11, and the shaft 12. The coil spring 11 is disposed in the large diameter cylinder part of the stepped through-hole 1a. And, the shaft 12 to whose upper end there has been fixed the front button 10 penetrates through the small diameter cylinder part from the large diameter cylinder part of the stepped through-hole 1a, and is disposed while being made movable in the axial direction. The lower end of the shaft 12 faces on the rubber switch 14 with the predetermined distance being spaced.

The switch part is constituted by the switch board 13 in which the switch pattern has been formed, and the rubber switch 14 fixed to the predetermined position on the switch pattern of the switch board 13. The switch board 13 to which the rubber switch 14 has been attached is disposed in the switch board attachment concave part of the battery frame 5 after the conducting coil spring 15 has been inserted into the conducting coil spring attachment hole formed in the battery frame 5 while penetrating through it. And, the switch board 13 disposed by doing like this is fixed to a panel frame 2 by the fact that the panel frame 2 and the battery frame 5 are fixed by fitting the panel frame 2 and the battery frame 5 together and catching a switch spring 8 to a hook locking window 8a.

Further, there may be adapted so as to directly, temporarily fix the switch spring 8 into the armoring case 1 without catching it to the hook locking window 8a.

The switch spring 8 is made of an elastically deformable metal like phosphor bronze and stainless steel. The switch spring 8 is a constitutional member indispensable for the electronic timepiece, and has an attaching hook portion for fixing to the panel frame 2, a battery plus terminal for contacting with a positive electrode of a battery 9, and the like.

In order to fix the switch board 13, the switch spring 8 is extended in a planar manner from an end part of a battery accommodation concave part in which the battery 9 has been accommodated to an outside of a lower face of the switch board 13, and additionally has an elastic end part bent at a right angle to an upper side in the outside of the switch board 13. The hook locking window 8a is formed in the elastic end part of the switch spring 8, and a hook 5a is formed in the battery frame 5 made of resin. The hook 5a is a protrusion of a triangular shape in section, and is molded monolithically with the battery frame made of resin. A formation position of the hook 5a is a place, of the battery frame 5, facing on the hook locking window 8a formed in an end part of the switch spring 8.

In an assembly, after disposing the switch board 13 in the switch attachment concave part of the battery frame 5, the switch spring 8 is incorporated from a back side of the movement. The hook locking window 8a formed in the end part of the switch spring 8 is locked to the hook 5a of the battery frame 5. By doing like this, the switch board 13 is fixed. Incidentally, in a case of the switch board 13 temporarily fixed into the armoring case 1, it is firmly fixed into the armoring case 1 if the case back 3 is closed.

By doing like this, the switch board 13 disposed between the battery frame 5 and the switch spring 8 is fixed with the battery frame 5 and the switch spring 8 being hook-fastened. Accordingly, a sectional position of the switch board 13 in the armoring case 1 is fixed, and the front switch structure becomes one unit. And, this unit is made a module while being set to the circuit board 7, a display panel 6 and the panel frame 2. By this module-making, a flow becomes possible under such a state intact that before the case back 3 is closed at an assemble time, so that a working efficiency has increased. Further, under the state that before the case back 3 is closed, the operation inspection of the front switch becomes possible, so that it has become possible to find out the defect after the assemble. Additionally, since the switch spring 8 that is the member indispensable for the electronic timepiece has been used also as a member for temporarily fixing the switch board 13 and the elastic member 17 disposed between the switch board 13 and the case back 3 in a conventional connection structure of the battery has been made unnecessary, the reduction in the number of components could be realized as well.

Further, there may be adapted such that the switch board 13 disposed between the battery frame 5 and the switch spring 8 is fixed with the panel frame 2 and the switch spring 8 being hook-fastened. Or, there may be adapted such that the switch board 13 disposed between the battery frame 5 and the switch spring 8 is fixed with the switch spring 8 being hook-fastened to both of the battery frame 5 and the panel frame 2.

By the present invention, there has become such that the front button disposed in the armoring case is made the same height as the display face or lower than the display face, and the switch board can be fixed by the simple constitution even if the case back is not closed. In other words, since it is possible to perform a module-making, the switch board can be fixed even if the case back is not closed. Further, under a state that before the case back is closed, the operation inspection of the front switch becomes possible, so that it has become possible to find out a defect after the assemble. Additionally, the elastic member disposed between the switch board and the case back in the conventional portable electronic timepiece becomes unnecessary, so that a reduction in the number of components could be realized as well.

What is claimed is:

1. A portable electronic timepiece comprising:
a circuit board having an IC;
a switch board provided in a position sectionally separated from the circuit board;
wherein the switch board is disposed between a battery frame and a switch spring, and an end part of the switch spring is locked to at least any one of the battery frame or a panel frame, thereby fixing the switch board.

2. A portable electronic timepiece according to claim 1, wherein a hook is fastening to locking the end part of the switch spring to at least any one of the battery frame or the panel frame.

3. A portable electronic timepiece according to claim 2, the hook fastening is performed by a hook locking window formed in the end part of the switch spring and a hook formed in at least any one of the battery frame or the panel frame.
